(19) United States
(12) Patent Application Publication
(10) Pub. No.: US 2020/0001510 A1
(43) Pub. Date: Jan. 2, 2020

(54) INJECTION COMPRESSION MOLDING MOLD AND INJECTION COMPRESSION MOLDING METHOD

(71) Applicant: MITSUBISHI ELECTRIC CORPORATION, Chiyoda-ku, Tokyo (JP)

(72) Inventors: Yuki Wakabayashi, Tokyo (JP); Yoshinori Kaneto, Tokyo (JP)

(73) Assignee: MITSUBISHI ELECTRIC CORPORATION, Chiyoda-ku, Tokyo (JP)

(21) Appl. No.: 16/094,946

(22) PCT Filed: May 23, 2017
(86) PCT No.: PCT/JP2017/019097

§ 371 Date: Oct. 19, 2018

(30) Foreign Application Priority Data
Jun. 8, 2016 (JP) 2016-114079

(51) Int. Cl. B29C 45/56; B29C 45/73

(52) U.S. Cl. CPC B29C 45/561; B29C 45/7312

(57) ABSTRACT

In the injection compression molding mold, cooling water passages are provided between a fixed-side surface formation portion and a heater, cooling water passages are provided between a movable-side surface formation portion and a heater, and a cavity is formed by the fixed-side surface formation portion, the movable-side surface formation portion, and a looped member. When the fixed-side surface formation portion and the movable-side surface formation portion are heated to predetermined temperature, resin is injected and filled into the cavity. Next, inside of the cavity is pressurized, and then heating is stopped and cooling water is supplied to the cooling water passages to perform cooling. Then, before the resin is completely solidified, the resin in the cavity is compressed while being cooled and solidified.

### TECHNICAL FIELD

The present invention relates to improvement in an injection compression molding mold and an injection compression molding method.

### BACKGROUND ART

As a conventional injection compression molding mold, the following injection molding mold is known. The injection molding mold has at least two dies combined to form a mold cavity between the dies, and is capable of forming a maximum mold cavity state having a larger volume than the product volume of a resin molded product to be injection-molded, and a minimum mold cavity state having a volume smaller than a volume obtained by subtracting a compressive elastic deformation volume of the resin molded product due to a clamping force from the product volume, and is configured such that, in a state of including melted resin injected and filled in the mold cavity, through die opening/closing operation of at least one die, the volume of the mold cavity can be expanded or reduced from one of the maximum mold cavity state and the minimum mold cavity state into the other state, and the clamping force can be applied substantially equally to the melted resin in the mold cavity until cooling and solidification of the melted resin in the mold cavity are completed (see, for example, Patent Document 1).

As another conventional injection compression molding mold, a synthetic resin molding mold is known in which a mold insert is divided into an insert front member having a cavity surface and an insert back member not having a cavity surface, the insert front member has grooves passing through a part near the cavity surface and extending from the back surface side of the insert front member toward the cavity surface, electric heaters are stored in the grooves, the grooves are closed by the insert back member, the electric heaters are positioned at the deepest parts of the grooves, the electric heaters are arranged so as to be divided into a plurality of systems, and a controller portion is provided which performs energization control for the electric heater in each system individually to perform control at different temperatures for respective heating zones (see, for example, Patent Document 2).

As still another conventional injection compression molding mold, a mold apparatus is known in which a molded product is formed when a cavity surface formed in a first die and a core surface formed in a second die are mated with each other, and the molded product is taken out when the first die and the second die are separated from each other, the mold apparatus including: a plurality of heaters which are arranged above the cavity surface and to which power is applied at the time of heating the first die; and a plurality of cooling water holes which are arranged above the heaters and through which cooling water is poured at the time of cooling the first die, wherein each cooling water hole is located between two heaters adjacent to each other with respect to the cavity surface so that the cooling water holes and the heaters are arranged alternately with respect to the cavity surface (see, for example, Patent Document 3).

### CITATION LIST

### Patent Document

Patent Document 1: Japanese Laid-Open Patent Publication No. 2014-151449

Patent Document 2: Japanese Laid-Open Patent Publication No. 2010-264703

Patent Document 3: Japanese Laid-Open Patent Publication No. 2010-094998

### SUMMARY OF THE INVENTION

### Problems to be Solved by the Invention

The conventional injection compression molding molds are configured as described above. In the injection molding mold in which the clamping force is applied substantially equally to melted resin in the mold cavity, while the melted resin has high fluidity, the clamping force can be equally given to the melted resin in the cavity, and thus excellent transfer can be performed and warp deformation can be suppressed. However, if the fluidity of the melted resin is decreased, the cooling state of the melted resin becomes uneven, and thus it might be difficult to equally give the clamping force because of deformation such as warp or sink due to residual stress in the resin during solidification and contraction.

On the other hand, in the synthetic resin molding mold in which the insert front member has grooves passing through a part near the cavity surface and extending from the back surface side of the insert front member toward the cavity surface and in which the electric heaters are stored in the grooves and the grooves are closed by the insert back member, the electric heaters are positioned and held in a close-contact state at the deepest parts of the grooves, whereby equal heat transfer distances are set for all parts of the cavity surface, so that it is expected that heating can be uniformly and rapidly performed to a desired temperature without uneven temperature increase. However, the cooling period is elongated and thus there is a limit on shortening of the molding cycle period. In the molding apparatus in which the cooling water holes and the heaters are alternately arranged with respect to the cavity surface, there is a possibility that the residual heat in heater heating cannot be appropriately and swiftly removed during cooling.

The present invention has been made to solve the above problems, and an object of the present invention is to obtain an injection compression molding mold capable of swiftly and appropriately performing heating and cooling, and provide an injection compression molding method that enables shortening of the molding cycle period and is capable of excellent transfer.

### Solution to the Problems

An injection compression molding mold according to the present invention includes a first die and a second die, the first die and the second die being arranged so as to be opposed to each other in a predetermined direction, at least the second die being movable in the predetermined direction relative to the first die. The first die has a first insert member and a first support member. The first insert member has a first surface formation portion, a first coolant passage, and a first heater. The first coolant passage is to be supplied with a coolant for cooling the first surface formation portion, and the first heater is for heating the first surface formation portion. The first coolant passage is provided between the first surface formation portion and the first heater. The first support member fixes and supports the first insert member. The second die has a second insert member, a looped member, and a second support member. The second insert member has a second surface formation portion, a second coolant passage, and a second heater. The second coolant passage is to be supplied with a coolant for cooling the second surface formation portion, and the second heater is for heating the second surface formation portion. The second coolant passage is provided between the second surface formation portion and the second heater. The looped member is provided so as to be looped around the second insert member in a direction perpendicular to the predetermined direction and so as to be slidable with respect to the second insert member in the predetermined direction. The second support member fixes and supports the second insert member. The first insert member and the second insert member are arranged such that the first surface formation portion and the second surface formation portion are opposed to each other in the predetermined direction. A cavity into which resin for molding a resin molded product is to be injected and filled is formed by the first surface formation portion, the looped member, and the second surface formation portion. By the second insert member being driven in the predetermined direction, a volume of the cavity is contractible in multiple stages from a first cavity state having a larger volume than a product volume of the resin molded product, to a second cavity state having a volume obtained by subtracting at least thermal contraction deformation volumes of the first insert member and second insert member from the product volume.

An injection compression molding method according to the present invention is an injection compression molding method using the above injection compression molding mold and including: a heating step of heating the first insert member and the second insert member by the first heater and the second heater; a first state setting step of driving the second die in the predetermined direction, to bring a volume of the cavity into the first cavity state; a filling step of injecting and filling melted resin into the cavity; a first compression step of, during the injection and filling or after the filling, driving the second die in the predetermined direction, to pressurize the melted resin filled in the cavity; a cooling step of supplying a coolant to the first coolant passage and the second coolant passage, to cool the filled resin; and a second compression step of, during the cooling step, bringing the volume of the cavity into the second cavity state.

### Effect of the Invention

The injection compression molding mold according to the present invention makes it possible to obtain an injection compression molding mold capable of swiftly and appropriately performing heating and cooling.

The injection compression molding method according to the present invention makes it possible to provide an injection compression molding method that enables shortening of the molding cycle period and is capable of excellent transfer.

### BRIEF DESCRIPTION OF THE DRAWINGS

FIG. 1 is a sectional view showing the configuration of an injection compression molding mold according to embodiment 1 of the present invention.

FIG. 2 is a flowchart showing a process of an injection compression molding method according to embodiment 1.

FIG. 3 is a sectional view showing the state of the injection compression molding mold in an injection compression molding process according to embodiment 1.

FIG. 4 is a sectional view showing the state of the injection compression molding mold in the injection compression molding process according to embodiment 1.

FIG. 5 is a sectional view showing the state of the injection compression molding mold in the injection compression molding process according to embodiment 1.

FIG. 6 is a sectional view showing the configuration of an injection compression molding mold according to embodiment 2.

FIG. 7 is a sectional view showing the configuration of an injection compression molding mold according to embodiment 3.

FIG. 8 is a sectional view showing the configuration of an injection compression molding mold according to embodiment 4.

FIG. 9 is a sectional view showing the configuration of an injection compression molding mold according to embodiment 5.

FIG. 10 is a sectional view showing the configuration of an injection compression molding mold according to embodiment 6.

### DESCRIPTION OF EMBODIMENTS

### Embodiment 1

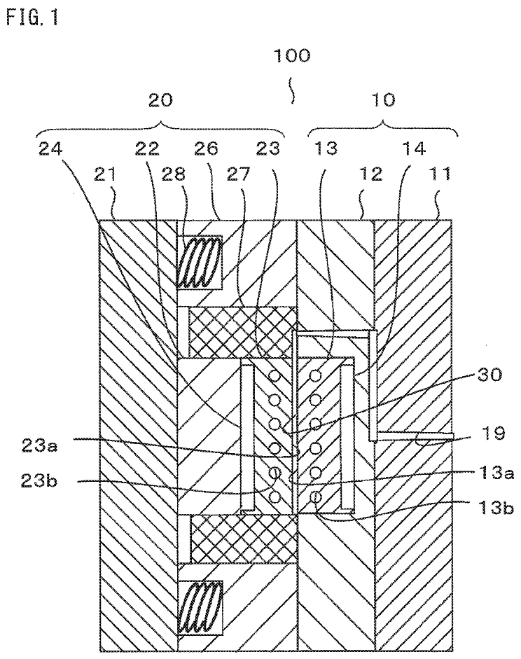

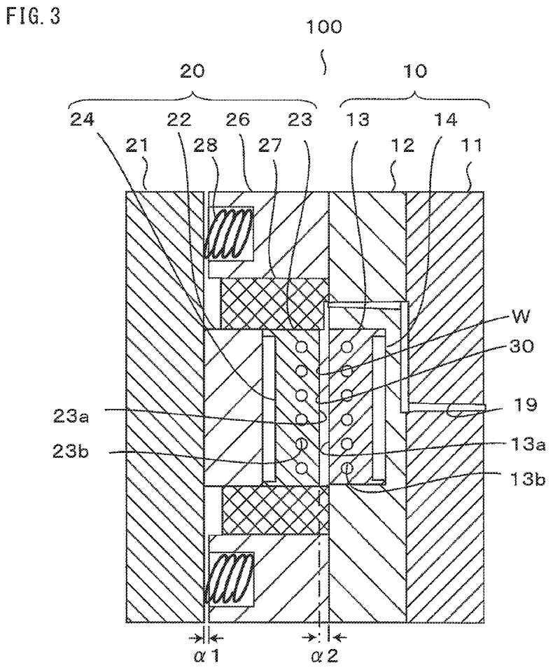

FIG. 1 to FIG. 5 show embodiment 1 for carrying out the present invention. FIG. 1 is a sectional view showing the configuration of an injection compression molding mold according to embodiment 1 for carrying out the present invention, and shows a state in which the volume of a cavity is reduced by clamping. FIG. 2 is a flowchart showing a process of an injection compression molding method, and FIG. 3 to FIG. 5 are sectional views showing the state of the injection compression molding mold in the injection compression molding process. In FIG. 1, an injection compression molding mold 100 has a fixed die 10 as a first die and a movable die 20 as a second die. The fixed die 10 has a fixed-side die member 11, a fixed-side support member 12 as a first support member, a fixed-side insert member 13, a heater 14, and a resin injection hole 19.

The fixed-side insert member 13 has a rectangular shape as seen from the left in FIG. 1, and has: a fixed-side surface formation portion 13a as a first surface formation portion having a flat surface, at the left in FIG. 1; and cooling water passages 13b formed inside the fixed-side surface formation portion 13a and having circular sectional shapes. A plurality of cooling water passages 13b are arranged so as to allow melted resin to be uniformly and rapidly cooled. The cooling water passages 13b are formed by the fixed-side insert member 13 being formed by stacking and diffusion-bonding a plurality of metal sheets prepared by photoetching, for example. The heater 14 is provided at a surface opposite to the fixed-side surface formation portion 13a, of the fixed-side insert member 13. That is, the cooling water passages 13b are located between the fixed-side surface formation portion 13a and the heater 14. The fixed-side insert member 13 is fixed to the fixed-side support member 12 so as to sandwich the heater 14 therebetween, and the fixed-side support member 12 is fixed to the fixed-side die member 11. The resin injection hole 19 which communicates with a cavity 30 described later is formed in the fixed-side die member 11, the fixed-side support member 12, and a looped member 27 described later.

The movable die 20 has a movable-side die member 21, a movable-side support member 22, a movable-side insert member 23, a heater 24, an intermediate member 26, the looped member 27, and a coil spring 28. The movable-side insert member 23 has a rectangular shape as seen from the right in FIG. 1, and has: a movable-side surface formation portion 23a as a second surface formation portion having a flat surface, at the right; and a plurality of cooling water passages 23b formed inside the movable-side surface formation portion 23a and having a circular sectional shape. A plurality of cooling water passages 23b are arranged so as to allow melted resin to be uniformly and rapidly cooled. The heater 24 is provided at a surface opposite to the movable-side surface formation portion 23a, of the movable-side insert member 23. That is, the cooling water passages 23b are located between the movable-side surface formation portion 23a and the heater 24. The cooling water passages 23b are formed by the movable-side insert member 23 being formed by stacking and diffusion-bonding a plurality of metal sheets prepared by photoetching, for example.

The movable-side insert member 23 is fixed to the movable-side support member 22 so as to sandwich the heater 24 therebetween, and the movable-side support member 22 is fixed to the movable-side die member 21. These four components are integrated. The intermediate member 26 is formed in a rectangular frame shape as seen from the left in FIG. 1, and the looped member 27 is fixed inside the intermediate member 26. The looped member 27 is provided so as to be looped around the movable-side insert member 23 and the movable-side support member 22 in a direction perpendicular to a predetermined direction which is a direction in which the movable die 20 is driven. The looped member 27 is supported so as to be slidable on the movable-side insert member 23 fixed and supported on the movable-side support member 22, and the looped member 27 and the movable-side insert member 23 have a predetermined slight gap therebetween so as to be slidable with each other in the predetermined direction and so as not to allow leakage of resin filled in the later-described cavity 30 at the time of resin compression molding. Between the movable-side die member 21 and the intermediate member 26, coil springs 28 are provided at four locations (two of these are shown in the sectional view in FIG. 1).

The fixed die 10 is attached to a fixed platen (not shown) of an injection molding machine. The movable die 20 is attached to a movable platen (not shown) of the injection molding machine. The fixed-side surface formation portion 13a formed on the fixed-side insert member 13 and the movable-side surface formation portion 23a formed on the movable-side insert member 23 are opposed to each other in the right-left direction in FIG. 1, which is the predetermined direction, and the movable platen and the movable die 20 are configured to move forward/backward in the right-left direction in FIG. 1 through opening/closing operation of the injection molding machine. When the intermediate member 26 of the movable die 20 is caused to abut on the fixed-side support member 12 of the fixed die 10, the rectangular parallelepiped cavity 30 having a small dimension in the right-left direction in FIG. 1 is formed by the fixed-side surface formation portion 13a, the movable-side surface formation portion 23a, and the looped member 27. Melted resin can be injected and filled into the cavity 30 through the resin injection hole 19 from a nozzle (not shown) of the injection molding machine.

In the present embodiment, the cooling water passages 13b and the heater 14, and the cooling water passages 23b and the heater 24, are arranged in characteristic structures, for the purpose of improvement in cooling and heating performance for the fixed-side surface formation portion 13a and the movable-side surface formation portion 23a. That is, in order to rapidly and uniformly cool the fixed-side insert member 13 and the movable-side insert member 23, the plurality of cooling water passages 13b as a first coolant passage and the plurality of cooling water passages 23b as a second coolant passage are respectively provided inside the fixed-side insert member 13 and the movable-side insert member 23. In addition, in order to rapidly and uniformly heat the fixed-side insert member 13 and the movable-side insert member 23, the heater 14 is provided at the surface opposite to the fixed-side surface formation portion 13a of the fixed-side insert member 13, and the heater 24 is provided at the surface opposite to the movable-side surface formation portion 23a of the movable-side insert member 23. Although not shown, a cooling unit is provided for supplying cooling water as a coolant to the cooling water passages 13b and the cooling water passages 23b, and an air unit (not shown) is provided for supplying compressed air into the cooling water passages 13b and the cooling water passages 23b so as to discharge the cooling water. In addition, a power supply unit (not shown) is provided for supplying power for heating to the heater 14 and the heater 24.

In such a configuration, since the fixed-side surface formation portion 13a and the movable-side surface formation portion 23a are rapidly heated using the heater 14 and the heater 24, it becomes possible to inject and fill melted resin into the cavity 30 in a state in which the fixed-side surface formation portion 13a and the movable-side surface formation portion 23a are uniformly heated to a temperature equal to or higher than a glass transition temperature or a crystallization temperature of a resin to be used for molding. In addition, by supplying cooling water to the cooling water passages 13b and the cooling water passages 23b, the temperatures of the fixed-side surface formation portion 13a and the movable-side surface formation portion 23a can be prevented from becoming uneven due to the residual heat at the time of heating the fixed-side surface formation portion 13a and the movable-side surface formation portion 23a, and it becomes possible to uniformly and rapidly decrease the temperatures of the fixed-side surface formation portion 13a and the movable-side surface formation portion 23a. That is, it is possible to cool and solidify the melted resin uniformly and within a short time. Owing to these operational effects, fluidity of the melted resin is enhanced, whereby transfer can be excellently performed, and warp, sink, or the like due to residual stress in the resin during solidification and contraction of the melted resin can be suppressed, and the molding cycle period can be shortened as compared to the conventional one.

Next, a method for performing injection compression molding using such an injection compression molding mold 100 will be described with reference to the flowchart in FIG. 2. In the manufacturing method described below, before the melted resin is injected, the volume of the cavity 30 is expanded in prospect of a compression amount, the movable-side insert member 23 is moved (advanced) rightward by a hydraulic cylinder at an appropriate timing after injection and filling, to pressurize and compress the resin filled in the cavity 30. First, while the fixed-side insert member 13 and the movable-side insert member 23 are heated by the heater 14 and the heater 24 being energized, the mold is set in an initial state shown in FIG. 3 (heating step and first state setting step, step S1). In the initial state of the mold, the distance between the movable-side die member 21 of the movable die 20 and the intermediate member 26 is set to a predetermined gap dimension α1, that is, the volume of the cavity 30 is set to a volume larger than the product volume (finished volume) of a resin molded product to be injection-molded. At this time, the movable-side surface formation portion 23a of the movable-side insert member 23 and the fixed-side surface formation portion 13a of the fixed-side insert member 13 are opposed to each other with a predetermined gap dimension (distance) α2 therebetween. In this state, the intermediate member 26 is pressed by the coil spring 28 rightward in FIG. 3 and abuts on the fixed-side support member 12, and the looped member 27 fixed and supported on the intermediate member 26 also moves together with the intermediate member 26 and abuts on the fixed-side support member 12.

In step S2, if the temperatures of the fixed-side insert member 13 and the movable-side insert member 23 have not reached a predetermined temperature yet, waiting is performed until the predetermined temperature is reached. If the temperatures of the fixed-side insert member 13 and the movable-side insert member 23 reach (have reached) the predetermined temperature in step S2, melted resin is injected and filled into the cavity 30 through the resin injection hole 19 under a predetermined pressure (filling step, step S3). In this state, the inside of the cavity 30 is in a pressure-held state under a certain pressure with the resin injected and casted therein. In this pressure-held state, cooling water is supplied to the cooling water passages 13b and the cooling water passages 23b, to start cooling the fixed-side surface formation portion 13a and the movable-side surface formation portion 23a (cooling step, step S4). Thus, cooling and solidification of the melted resin in the cavity 30 are promoted. It is noted that the movable-side support member 22 and the movable-side insert member 23 are slidable on the inner peripheral part of the looped member 27 in the right-left direction in FIG. 3, and the cavity 30 formed by the fixed-side surface formation portion 13a, the movable-side surface formation portion 23a, and the looped member 27 is assuredly sealed so that the injected and filled resin does not leak.

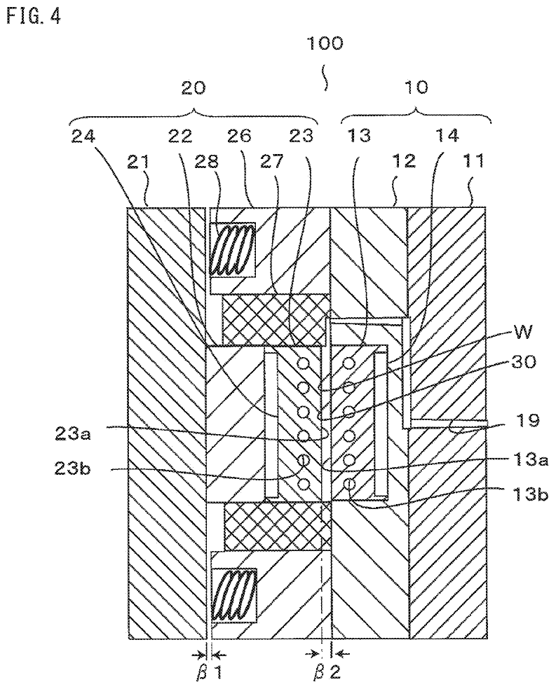

At an appropriate timing during the injection and filling or after the filling, the movable-side die member 21 is driven rightward in FIG. 3 by a predetermined force, so that the gap dimension between the movable-side die member 21 and the intermediate member 26 is reduced from α1 to β1, leading to a state shown in FIG. 4 (first compression step, step S5). At this time, the movable-side surface formation portion 23a is opposed to the fixed-side surface formation portion 13a with a predetermined gap dimension β2 therebetween. The driving (pressing) of the movable-side die member 21 is performed by, for example, supplying oil with a predetermined pressure to a hydraulic cylinder (not shown). The gap dimension β1 is set to such a dimension as to sufficiently compensate for subsequent volume reduction due to thermal contraction of the resin in the cavity 30 and subsequent dimension reduction in the right-left direction in FIG. 4 due to temperature drop of the fixed-side insert member 13 and the movable-side insert member 23. It is noted that the cooling step (step S4) may be started after the first compression step (step S5) is started, or these steps may be performed at the same time.

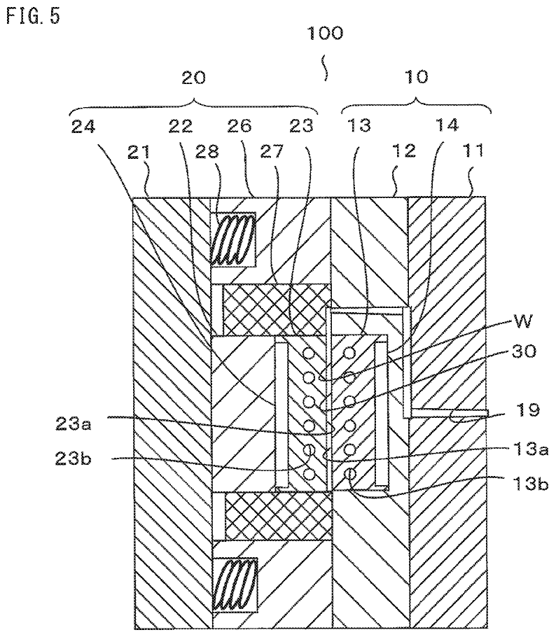

Thereafter, in the cooling step, before the melted resin is cooled and solidified, a clamping force is further applied (the movable-side die member 21 is driven rightward), whereby the volume of the cavity 30 is reduced to a volume obtained by subtracting (i.e., so as to compensate for) the amount of volume decrease due to thermal contraction of the injected and filled resin, the amount of volume decrease due to elastic deformation caused by compression of the filled resin, and the amount of dimension decrease due to thermal contraction of the fixed-side insert member 13 and the movable-side insert member 23, from the final volume of the resin molded product W, so that the movable-side insert member 23 is moved until the movable-side insert member 23 has a slight gap (not shown in FIG. 5) from the fixed-side insert member 13, leading to a state shown in FIG. 5 (second compression step, step S6). In FIG. 5, the gap dimension between the movable-side die member 21 and the intermediate member 26 is almost zero. When cooling and solidification of the melted resin are about to be completed, supply of cooling water to the cooling water passages 13b and the cooling water passages 23b is stopped, and compressed air is injected to the cooling water passages 13b and the cooling water passages 23b, to remove the residual cooling water in the cooling water passages 13b and the cooling water passages 23b, that is, the residual cooling water is discharged by blowing air (coolant discharge step, step S7). Thus, the cooling step is completed. When the cooling step has been completed, as shown in FIG. 5, the movable-side die member 21 has been moved to such a position that the gap dimension between the movable-side die member 21 and the intermediate member 26 is almost zero, and the resin molded product W in the cavity 30 has been compressed and elastically deformed so that the volume thereof has been decreased. In this state, the volume of the cavity 30 is a volume obtained by subtracting an amount of the elastic deformation from the product volume of the resin molded product. It is noted that, strictly speaking, depending on the resin type, the dimension might be slightly reduced due to subsequent temperature drop. Thereafter, the fixed die 10 and the movable die 20 are separated from each other, and the resin molded product W is released from the mold and taken out (step S8). The resin molded product W has a rectangular plate shape.

After the resin molded product W is taken out, if manufacturing has not been finished in step S9, the movable-side insert member 23 immediately starts moving to return to the initial state shown in FIG. 3. At the same time as the returning operation or with some delay, that is, so as to overlap with the movement of the movable-side insert member 23, the fixed-side insert member 13 and the movable-side insert member 23 are heated (step S10), while the process returns to step S1 which is the initial state in FIG. 3, to repeat the steps subsequent to step S1. It is noted that the heating of the fixed-side surface formation portion 13a and the movable-side surface formation portion 23a may be started at the same time as start of taking out of the resin molded product W. If the heating is started at least by the time when the movable-side insert member 23 returns to the initial state in step S1, the cycle period can be further shortened.

In such a configuration and a manufacturing method, the fixed-side surface formation portion 13a and the movable-side surface formation portion 23a are rapidly heated using the heater 14 and the heater 24, and the heating is started by the time when the movable-side insert member 23 returns to the initial state in FIG. 3, that is, the heating is performed so as to overlap with the first state setting step. Therefore, the molding cycle period can be shortened. In addition, the heating can be performed to a temperature equal to or higher than a glass transition temperature or a crystallization temperature of a resin to be used for injection molding, and it is possible to inject and fill the melted resin into the cavity 30 in a state in which the fixed-side surface formation portion 13a and the movable-side surface formation portion 23a are swiftly and appropriately heated within a short time so as to have a uniformed temperature distribution. Therefore, fluidity of the melted resin filled in the cavity 30 is enhanced, whereby transfer can be performed more finely and excellently than in the conventional case. In addition, since the cooling water passages 13b are provided between the heater 14 and the fixed-side surface formation portion 13a, and the cooling water passages 23b are provided between the heater 24 and the movable-side surface formation portion 23a, it is possible to reduce influence of the residual heat in heating of the fixed-side surface formation portion 13a and the movable-side surface formation portion 23a.

Further, the cooling water is supplied to the cooling water passages 13b and the cooling water passages 23b immediately after resin is injected and filled into the cavity 30. Thus, it is possible to reduce influence of the residual heat in heating of the fixed-side surface formation portion 13a and the movable-side surface formation portion 23a and swiftly remove the residual heat, and also, it is possible to swiftly lower the temperatures of the fixed-side surface formation portion 13a and the movable-side surface formation portion 23a into an appropriate state having less temperature unevenness. Since the fixed-side surface formation portion 13a and the movable-side surface formation portion 23a are swiftly cooled into an appropriate state having less temperature unevenness, the melted resin in the cavity 30 can be cooled and solidified uniformly and within a short time. In addition, until the melted resin is cooled and solidified, the melted resin is kept at a certain pressure. Therefore, warp, sink, or the like due to residual stress in the resin during solidification and contraction of the melted resin can be suppressed. In addition, owing to the above, the cycle period of injection molding can be also shortened.

During a period from the injection filling step to the cooling step in the molding cycle, the cavity 30 is changed in multiple stages from the first cavity state having a larger volume than the product volume of the resin molded product to be injection-molded, to the second cavity state having a volume obtained by subtracting at least an amount of volume decrease due to thermal contraction until the resin filled in the cavity 30 is cooled and contracted to be the resin molded product W, and an amount of volume decrease due to temperature change of the fixed-side insert member 13 and the movable-side insert member 23. Thus, as the temperature changes, the movable-side insert member 23 is driven rightward in FIG. 3, whereby the resin molded product W in the cavity 30 can be pressurized. That is, compression of the volume of the cavity 30 from the injection filling until completion of cooling in the molding cycle is performed in multiple stages. The present embodiment has shown an example in which the volume of the cavity 30 is compressed by an amount including elastic deformation due to pressurization of the resin filled in the cavity 30. However, it is not always necessary to take the amount of the elastic deformation into consideration.

In such a configuration, injection and filling are performed in a state in which the temperatures of the fixed-side surface formation portion 13a and the movable-side surface formation portion 23a are set to be equal to or higher than the glass transition temperature. Therefore, fluidity of the resin filled in the cavity 30 is ensured, and the melted resin can be filled at high speed. In addition, during a period until cooling and solidification of the melted resin are completed, cooling water is passed through the cooling water passages 13b and the cooling water passages 23b to perform cooling. Therefore, it is possible to suppress unevenness of the temperatures of the fixed-side surface formation portion 13a and the movable-side surface formation portion 23a due to the residual heat when the fixed-side surface formation portion 13a and the movable-side surface formation portion 23a are heated by the heater 14 and the heater 24. Thus, the fixed-side surface formation portion 13a and the movable-side surface formation portion 23a can be more uniformly cooled.

In addition, during a period until the resin injected and filled in the cavity 30 is solidified, the movable-side insert member 23 is moved toward the fixed-side insert member 13 so as to further reduce the volume of the cavity 30 from the volume immediately after filling of the resin, that is, two stages of compression steps composed of the first compression step (step S5) and the second compression step (step S6) are provided. Therefore, it is possible to reduce a gap that might occur between the melted resin (resin molded product W) and each of the fixed-side surface formation portion 13a and the movable-side surface formation portion 23a due to thermal contraction deformation of the fixed-side insert member 13 and the movable-side insert member 23, or the contact area between the melted resin and each of the fixed-side surface formation portion 13a and the movable-side surface formation portion 23a can be ensured, and thus the melted resin can be uniformly and rapidly cooled. In addition, the resin can be prevented from leaking from each interface among the fixed-side support member 12, the fixed-side insert member 13, the movable-side insert member 23, and the looped member 27 due to cooling and contraction of the fixed-side insert member 13 and the movable-side insert member 23, and thus it becomes possible to reliably pressurize the melted resin (resin molded product W) in the cavity 30 by applying a clamping force to the movable-side die member 21. Therefore, as compared to the conventional case, warp, sink, or the like due to residual stress in the resin molded product W during solidification and contraction of the melted resin can be suppressed, and also, the molding cycle period can be further shortened.

As described above, the present embodiment makes it possible to swiftly and appropriately heat and cool the mold. Therefore, as compared to the conventional case, the molding cycle period can be shortened, fine transfer can be performed excellently, and deformation such as warp or sink of the resin molded product W is suppressed, whereby the quality of the resin molded product can be improved.

### Embodiment 2

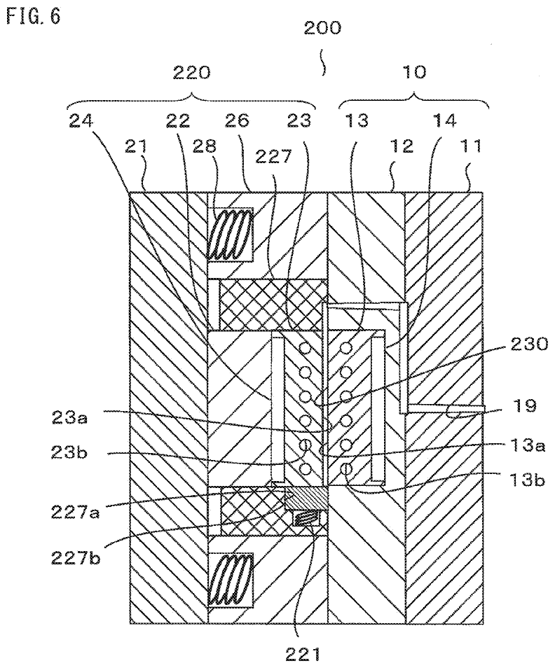

FIG. 6 is a sectional view showing the configuration of an injection compression molding mold according to embodiment 2. In FIG. 6, an injection compression molding mold 200 has a movable die 220 as a second die. The movable die 220 has a looped member 227 and a spring 221. The looped member 227 has a cutout portion 227a and a sliding member 227b. The cutout portion 227a is provided in one side (side on the lower side in FIG. 6) of the rectangular looped member 227 provided so as to be looped around the rectangular parallelepiped movable-side insert member 23, and the cutout portion 227a stores the sliding member 227b and the spring 221. The sliding member 227b abuts on the lower-side surface of the movable-side insert member 23 by being pressed thereto with a predetermined force by the spring 221. The movable-side insert member 23 is smoothly slidable in the right-left direction in FIG. 6 on the looped member 227 provided so as to be looped around the movable-side insert member 23 and including the sliding member 227b, and the cavity 230 formed by the movable-side insert member 23, the looped member 227 including the sliding member 227b, and the fixed-side insert member 13 is sufficiently sealed so as not to allow leakage of the filled resin during pressurization. The other configurations are the same as those shown in FIG. 1 in embodiment 1. Therefore, the corresponding parts are denoted by the same reference characters and the description thereof is omitted. In addition, a manufacturing method for manufacturing a resin molded product using such an injection compression molding mold 200 is the same as in embodiment 1.

The sliding member 227b and the spring 221 may be provided also to another one side (side parallel to the drawing plane of FIG. 6) of the looped member 227 so that the movable-side insert member 23 is pressed in the right-left direction and in the up-down direction in FIG. 6. Instead of the spring 221, an air cylinder, a hydraulic cylinder, an actuator, or the like may be used. In the case of using an air cylinder, a hydraulic cylinder, an actuator, or the like, it is preferable to control driving of the sliding member 227b in cooperation with movement of the movable-side insert member 23.

Such a configuration can more easily prevent galling or gap formation between the movable-side insert member 23 and the looped member 227 due to thermal expansion/contraction deformation of the movable-side insert member 23 in the molding cycle. In addition, when the cavity 230 is compressed, even if a clamping force is applied to the melted resin, there is no possibility of resin leakage. Therefore, it is possible to manufacture a resin molded product without causing burr or warp of the resin molded product due to flow of melted resin between the movable-side insert member 23 and the looped member 227.

### Embodiment 3

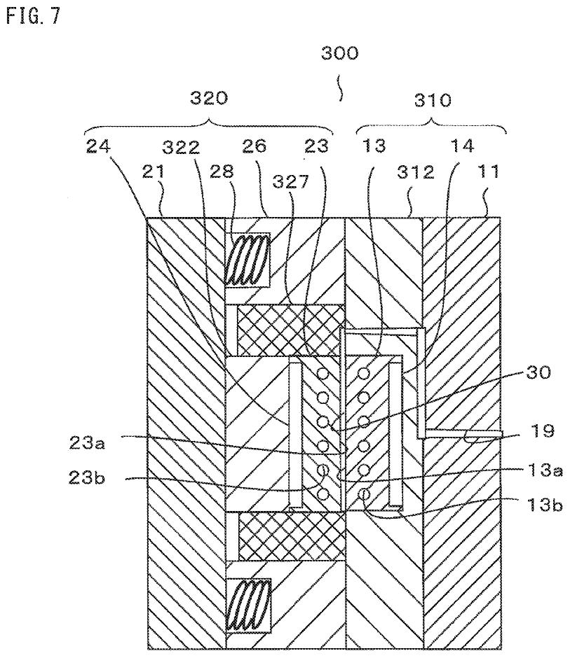

FIG. 7 is a sectional view showing the configuration of an injection compression molding mold according to embodiment 3. In FIG. 7, an injection compression molding mold 300 has a fixed die 310 as a first die and a movable die 320 as a second die. The fixed die 310 has a fixed-side support member 312 as a first support member, which is made from a thermal insulation material, instead of the fixed-side support member 12 shown in FIG. 1. The movable die 320 has a looped member 327 and a movable-side support member 322 as a second support member, which are made from a thermal insulation material, instead of the looped member 27 and the movable-side support member 22 shown in FIG. 1. The other configurations are the same as those shown in FIG. 1 in embodiment 1. Therefore, the corresponding parts are denoted by the same reference characters and the description thereof is omitted. In addition, a manufacturing method for manufacturing a resin molded product using such an injection compression molding mold 300 is the same as in embodiment 1.

Such a configuration makes it possible to efficiently perform heating of the fixed-side surface formation portion 13a and the movable-side surface formation portion 23a by the heater 14 and the heater 24, and cooling of the fixed-side surface formation portion 13a and the movable-side surface formation portion 23a by supplying cooling water to the cooling water passages 13b and the cooling water passages 23b. Therefore, it becomes possible to further shorten the molding cycle period as compared to the conventional case. It is noted that, instead of replacing all of the fixed-side support member 12, the looped member 27, and the movable-side support member 22 shown in FIG. 1 with the fixed-side support member 312, the looped member 327, and the movable-side support member 322, some of them may be replaced and also in this case, a thermal insulation effect is obtained accordingly.

### Embodiment 4

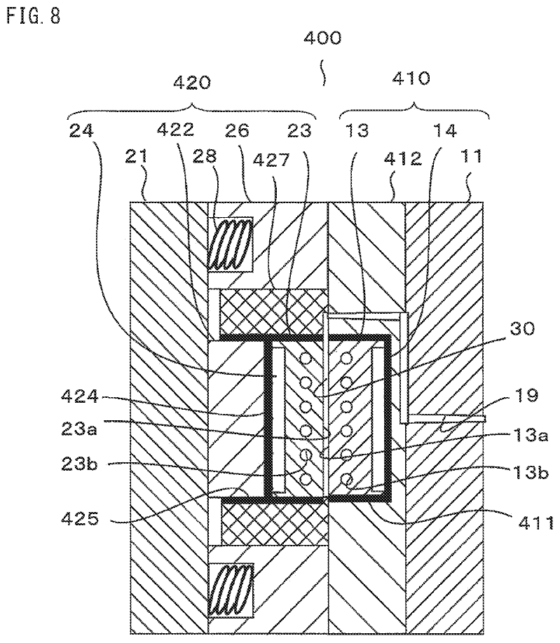

FIG. 8 is a sectional view showing the configuration of an injection compression molding mold according to embodiment 4. In FIG. 8, an injection compression molding mold 400 has a fixed die 410 as a first die and a movable die 420 as a second die. The fixed die 410 has a thermal insulation member 411 and a fixed-side support member 412 as a first support member. The movable die 420 has a movable-side support member 422 as a second support member, a thermal insulation member 424, a thermal insulation member 425, and a looped member 427. The thermal insulation member 411 which is made from a thermal insulation material is provided between the fixed-side insert member 13 and the fixed-side support member 412. The thermal insulation member 424 which is made from a thermal insulation material is provided between the movable-side insert member 23 and the movable-side support member 422, and the thermal insulation member 425 which is made from a thermal insulation material is provided between the movable-side insert member 23 and the looped member 427. The fixed-side support member 412 is thinned by an amount corresponding to the thickness of the thermal insulation member 411, but is similar to the fixed-side support member 12 shown in FIG. 1. The movable-side support member 422 and the looped member 427 are thinned by an amount corresponding to the thicknesses of the thermal insulation member 424 and the thermal insulation member 425, but are similar to the movable-side support member 22 and the looped member 27 shown in FIG. 1. In this case, for example, the movable-side insert member 23 is slidable with respect to the thermal insulation member 425. The other configurations are the same as those shown in FIG. 1 in embodiment 1. Therefore, the corresponding parts are denoted by the same reference characters and the description thereof is omitted. In addition, a manufacturing method for manufacturing a resin molded product using such an injection compression molding mold 400 is the same as in embodiment 1.

Such a configuration makes it possible to efficiently perform heating of the fixed-side surface formation portion 13a and the movable-side surface formation portion 23a by the heater 14 and the heater 24, and cooling of the fixed-side surface formation portion 13a and the movable-side surface formation portion 23a by supplying cooling water to the cooling water passages 13b and the cooling water passages 23b. Therefore, it becomes possible to further shorten the molding cycle period as compared to the conventional case. It is noted that, instead of providing all of the thermal insulation member 411, the thermal insulation member 424, and the thermal insulation member 425, some of them may be provided and also in this case, a thermal insulation effect is obtained accordingly.

### Embodiment 5

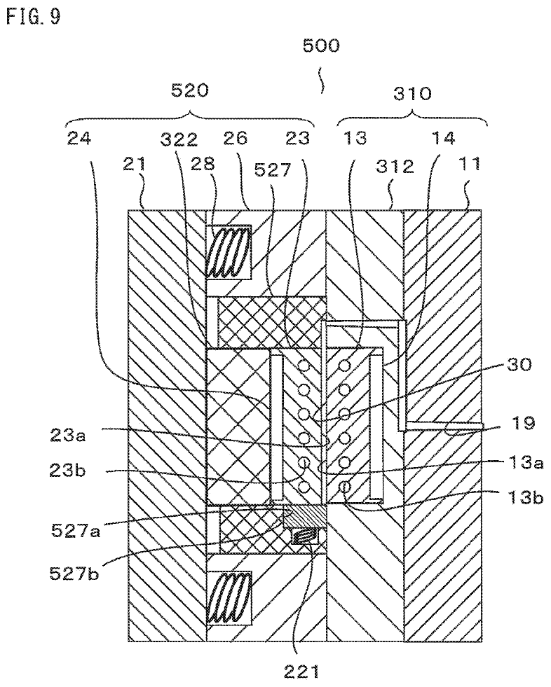

FIG. 9 is a sectional view showing the configuration of an injection compression molding mold according to embodiment 5. In FIG. 9, an injection compression molding mold 500 has a fixed die 310 as a first die and a movable die 520 as a second die. The fixed die 310 is the same as the fixed die 310 shown in FIG. 7. The movable die 520 has a movable-side support member 322 and a looped member 527 which are made from a thermal insulation material, instead of the movable-side support member 22 and the looped member 227 shown in FIG. 6. The looped member 527 has a sliding member 527b provided in a cutout portion 527a and made from a thermal insulation material. The other configurations are the same as those shown in FIG. 6 in embodiment 2. Therefore, the corresponding parts are denoted by the same reference characters and the description thereof is omitted. In addition, a manufacturing method for manufacturing a resin molded product using such an injection compression molding mold 500 is the same as in embodiment 1.

Such a configuration makes it possible to efficiently perform heating of the fixed-side surface formation portion 13a and the movable-side surface formation portion 23a by the heater 14, and cooling of the fixed-side surface formation portion 13a and the movable-side surface formation portion 23a by supplying cooling water to the cooling water passages 13b. Therefore, it becomes possible to further shorten the molding cycle period as compared to the conventional case.

### Embodiment 6

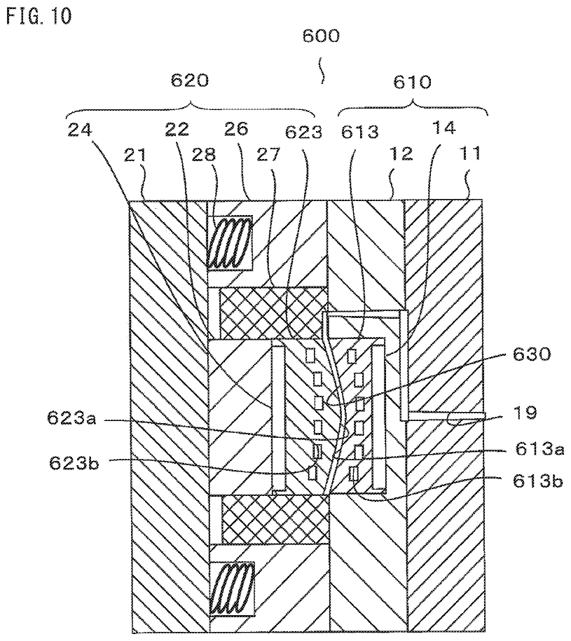

FIG. 10 is a sectional view showing the configuration of an injection compression molding mold according to embodiment 6. In FIG. 10, an injection compression molding mold 600 has a fixed die 610 as a first die and a movable die 620 as a second die. The fixed die 610 has a fixed-side insert member 613 as a first insert member. The movable die 620 has a movable-side insert member 623 as a second insert member. The fixed-side insert member 613 has a fixed-side surface formation portion 613a as a first surface formation portion and cooling water passages 613b as a first coolant passage. The movable-side insert member 623 has a movable-side surface formation portion 623a as a second surface formation portion and cooling water passages 623b as a second coolant passage. The fixed-side surface formation portion 613a and the movable-side surface formation portion 623a have curved surfaces, and are arranged so as to be opposed to each other to form a cavity 630 together with a looped member 27.

In the present embodiment, a plate-like resin molded product having a cross section curved in a bow shape is manufactured. It is preferable to form the cooling water passage 613b and the cooling water passage 623b in three-dimensional shapes along the curved shapes of the fixed-side surface formation portion 613a and the movable-side surface formation portion 623a, so as to enable melted resin to be uniformly cooled in the case of manufacturing a resin molded product having a curved shape or a resin molded product having a thickness varying part by part. A plurality of cooling water passages 613b and a plurality of cooling water passages 623b are arranged along the shape of the resin molded product, whereby uniform cooling can be performed. In addition, a manufacturing method for manufacturing a resin molded product using such an injection compression molding mold 600 is the same as in embodiment 1.

In the above embodiments, the cooling water passages 13b and the cooling water passages 23b may be formed by: forming, for example, a groove-like portion having a corrugated-tube shape by cutting, grinding, or electric-discharge working; covering the groove-like portion with a plate-like member as a lid; and then joining them by brazing or the like. Alternatively, these may be formed by casting with a corrugated tube embedded. Also the heater 14 and the heater 24 may be formed by embedded casting.

In the above description, the case of using water as a coolant supplied to the cooling water passages 13b and the cooling water passages 13b has been described. However, without limitation to water, oil, air, or the like may be used, whereby the same effects are obtained. Temperature sensors may be provided to the fixed-side insert member 13 and the movable-side insert member 23, to perform control of a flow amount and a flow period of the cooling water and control of supplied power and an energization period for the heater 14 and the heater 24, whereby the temperatures of the fixed-side insert member 13 and the movable-side insert member 23 can be controlled. Instead of the coil spring 28 and the spring 221, an air cylinder, a hydraulic cylinder, an actuator, or the like may be used to perform expansion and reduction of the volume of the cavity.

For example, in FIG. 1 in embodiment 1, a distance sensor or a position sensor for confirming the distance between the movable-side die member 21 and the intermediate member 26, i.e., the gap between the movable-side surface formation portion 23a and the fixed-side surface formation portion 13a, may be provided, and expansion and reduction of the volume of the cavity 30 may be adjusted through adjustment of the gap dimensions α1, β1 between the movable-side die member 21 and the intermediate member 26. As means for driving the movable-side die member 21, an air cylinder, an actuator, or the like which is driven by compressed air may be used instead of the hydraulic cylinder, to perform control of the volume of the cavity 30 and control of the pressure in the cavity 30.

The cavity compression process after start of the injection and filling step until cooling and solidification of the melted resin are completed may be divided into three or more stages of compression, instead of two stages of compression composed of the first compression step (step S5 (FIG. 2)) and the second compression step (step S6 (FIG. 2)) as described above. A movable die may be used instead of the first die.

It is noted that, within the scope of the present invention, the above embodiments may be freely combined with each other, or each of the above embodiments may be modified or simplified as appropriate.

1. An injection compression molding mold comprising a first die and a second die, the first die and the second die being arranged so as to be opposed to each other in a predetermined direction, at least the second die being movable in the predetermined direction relative to the first die, wherein
the first die has a first insert member and a first support member,
the first insert member has a first surface formation portion, a first coolant passage, and a first heater,
the first coolant passage is to be supplied with a coolant for cooling the first surface formation portion, and the first heater is for heating the first surface formation portion,
the first coolant passage is provided between the first surface formation portion and the first heater,
the first support member fixes and supports the first insert member,
the second die has a second insert member, a looped member, and a second support member,
the second insert member has a second surface formation portion, a second coolant passage, and a second heater,
the second coolant passage is to be supplied with a coolant for cooling the second surface formation portion, and the second heater is for heating the second surface formation portion,
the second coolant passage is provided between the second surface formation portion and the second heater,
the looped member is provided so as to be looped around the second insert member in a direction perpendicular to the predetermined direction and so as to be slidable with respect to the second insert member in the predetermined direction,
the second support member fixes and supports the second insert member,
the first insert member and the second insert member are arranged such that the first surface formation portion and the second surface formation portion are opposed to each other in the predetermined direction,
a cavity into which resin for molding a resin molded product is to be injected and filled is formed by the first surface formation portion, the looped member, and the second surface formation portion, and
by the second insert member being driven in the predetermined direction, a volume of the cavity is contractible in multiple stages from a first cavity state having a larger volume than a product volume of the resin molded product, to a second cavity state having a volume obtained by subtracting at least thermal contraction deformation volumes of the first insert member and second insert member from the product volume.

2. The injection compression molding mold according to claim 1, wherein
the looped member has a sliding member, and
the sliding member is provided so as to abut, with a predetermined pressure, on the second insert member in a direction perpendicular to the predetermined direction, and so as to be slidable with respect to the second insert member in the predetermined direction.

3. The injection compression molding mold according to claim 1, wherein
at least one of the first support member, the looped member, and the second support member is made from a thermal insulation material.

4. The injection compression molding mold according to claim 1, wherein
a thermal insulation member made from a thermal insulation material is provided in at least one of part between the first support member and the first insert member, part between the looped member and the second insert member, and part between the second support member and the second insert member.

5. An injection compression molding method using the injection compression molding mold according to claim 1, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

6. The injection compression molding method according to claim 5, further comprising a coolant discharge step of, prior to the heating step, blowing air into the first coolant passage and the second coolant passage, to discharge the coolant from inside of the first coolant passage and the second coolant passage.

7. The injection compression molding method according to claim 5, wherein
the first state setting step and the heating step are performed so as to overlap with each other.

8. The injection compression molding mold according to claim 2, wherein
at least one of the first support member, the looped member, and the second support member is made from a thermal insulation material.

9. The injection compression molding mold according to claim 2, wherein
a thermal insulation member made from a thermal insulation material is provided in at least one of part between the first support member and the first insert member, part between the looped member and the second insert member, and part between the second support member and the second insert member.

10. An injection compression molding method using the injection compression molding mold according to claim 2, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

11. An injection compression molding method using the injection compression molding mold according to claim 3, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

12. An injection compression molding method using the injection compression molding mold according to claim 4, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

13. An injection compression molding method using the injection compression molding mold according to claim 8, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

14. An injection compression molding method using the injection compression molding mold according to claim 9, the method comprising:
a heating step of heating the first insert member and the second insert member by the first heater and the second heater;
a first state setting step of driving the second die in the predetermined direction, to bring a volume of the cavity into the first cavity state;
a filling step of injecting and filling melted resin into the cavity;
a first compression step of, during the injection and filling or after the filling, driving the second die in the predetermined direction, to pressurize the melted resin filled in the cavity;
a cooling step of supplying a coolant to the first coolant passage and the second coolant passage, to cool the filled resin; and
a second compression step of, during the cooling step, bringing the volume of the cavity into the second cavity state.

15. The injection compression molding method according to claim 10, further comprising a coolant discharge step of, prior to the heating step, blowing air into the first coolant passage and the second coolant passage, to discharge the coolant from inside of the first coolant passage and the second coolant passage.

16. The injection compression molding method according to claim 11, further comprising a coolant discharge step of, prior to the heating step, blowing air into the first coolant passage and the second coolant passage, to discharge the coolant from inside of the first coolant passage and the second coolant passage.

17. The injection compression molding method according to claim 12, further comprising a coolant discharge step of, prior to the heating step, blowing air into the first coolant passage and the second coolant passage, to discharge the coolant from inside of the first coolant passage and the second coolant passage.

18. The injection compression molding method according to claim 13, further comprising a coolant discharge step of, prior to the heating step, blowing air into the first coolant passage and the second coolant passage, to discharge the coolant from inside of the first coolant passage and the second coolant passage.

19. The injection compression molding method according to claim 14, further comprising a coolant discharge step of, prior to the heating step, blowing air into the first coolant passage and the second coolant passage, to discharge the coolant from inside of the first coolant passage and the second coolant passage.

20. The injection compression molding method according to claim 6, wherein
the first state setting step and the heating step are performed so as to overlap with each other.
